(19) United States
(12) Patent Application Publication
(10) Pub. No.: US 2009/0030116 A1
(43) Pub. Date: Jan. 29, 2009

(54) Method and Composition for Producing an Item

(75) Inventor: Raffaella Di Girolamo, Roma (IT)

Correspondence Address: NIXON & VANDERHYE, PC, 901 NORTH GLEBE ROAD, 11TH FLOOR, ARLINGTON, VA, 22203, US

(73) Assignee: KEIPER HOLDING S.R.L., Vicenza (IT)

(21) Appl. No.: 11/887,645

(22) PCT Filed: Mar. 31, 2006
(86) PCT No.: PCT/IB2006/000765

§ 371 Date: Dec. 17, 2007

(30) Foreign Application Priority Data
Apr. 1, 2005 (IT) MO2005A000076

(51) Int. Cl. C04B 24/40

(52) U.S. Cl. 524/2

(57) ABSTRACT

A composition for producing a building item comprises: finely subdivided inert materials, an alkali metal polysilicate, an oxidizing agent, formaldehyde; a method for producing a building item comprises: dispersing finely subdivided inert materials in a solution of an alkali metal polysilicate, so as to obtain a mixture; adding an oxidizing agent and formaldehyde to said mixture; pouring said mixture into a mould, so as to enable said mixture to expand in volume, solidify and produce said item; drying said item.

The invention relates to a method and a composition for producing an item that can be made by forming in a mould, particularly a brick or a building panel.

Bricks of the known type, which have to be provided with mechanical properties (for example resistance to compression) set by regulations in force, are produced from clay-based compositions. The clay is mixed with water and placed in an extruding apparatus, from which an extruded product exits that consists of a continuous block of wet clay to which a preset shape has been given. The extruded product is then cut into portions of a desired length and the portions are then dried and sent to a kiln to be baked. Through the method disclosed above, the duration of which is comprised between 24 and 48 hours, it is possible to make two types of item, namely solid bricks, having a specific weight of approximately 1600-1800 kg/m³, and hollow bricks, having a specific weight of approximately 800 kg/m³.

A drawback of the known method is due to the significant length of the item manufacturing cycle, which is due to the time required by the drying and baking steps.

Furthermore, the latter have to be performed in suitable apparatuses, namely dryers and kilns, which complicates the structure of the manufacturing plant.

Another drawback is due to the substantially high specific weight of known bricks, which significantly influences the handling of the latter. In fact, in view of the weight of known bricks, it is not possible to exploit completely the loading volume that is theoretically available in an industrial motor vehicle, which is used to transport the bricks from the place of production, i.e. the brickyard, to the place of use, i.e. a building site. This means that a brick manufacturer, in order to be able to deliver his products to several customers, is obliged to use several motor vehicles simultaneously or to use, on several consecutive journeys, the same motor vehicle, which motor vehicle, after completing a delivery, then has to return to the brickyard and to be again loaded with bricks in order to be able to make the next delivery. This significantly increases the transport costs of a brickyard, and greatly limits the commercial range of action thereof.

A further drawback associated with the high specific weight of the known bricks is that the high specific weight causes, in use, significant static loads in the buildings made through the aforementioned bricks.

Known hollow bricks, although they are lighter than solid bricks, have the drawback of having reduced mechanical resistance inasmuch as the mechanical resistance is dependent on the orientation of the holes.

Another further drawback of the known bricks consists of the fact that the latter provide poor insulation against heat and noise, which, especially in residential buildings, makes necessary the use of thermal insulating, sound-absorbing and/or sound-insulating materials to be associated with the walls that are made of bricks.

Still another drawback of known bricks consists of the fact that, in order to lay the latter, mortar is required. This material, in addition to cementing the bricks together, enables the gaps to be closed that form between the bricks due to the substantially irregular conformation thereof. However, mortar is an inconvenient material to manage on a building site and it substantially weakens brick structures. Furthermore, as mortar is a heat conductor, it contributes to making the bricks poor insulators against heat, with consequent formation of thermal bridges.

An object of the invention is to improve the known methods for producing building item, in particular bricks.

Another object is to provide a method for producing building items, in particular bricks, that is significantly more rapid than the known methods.

A further object is to provide a method for producing building items, in particular bricks, that enables the use of complicated apparatuses, such as known kilns, to be avoided.

Another further object is to provide a composition that is usable for producing building items, in particular bricks, having a clay content that is substantially less than that of known compositions and such as to provide the items with mechanical properties that conform to regulations in force. A further other object is to supply a building item, in particular a brick, that is provided with a specific weight substantially lower than that of known items, so as to determine reduced static loads in the buildings in which it is used and to enable the loading volume of the motor vehicles by means of which it is transported to be completely exploited, thus increasing the commercial range of action of companies producing building items.

A still further other object is to provide a building item, in particular a brick, that is provided with insulating properties, both acoustic and thermal.

Still another further object is to provide a building item, in particular a brick, that can be laid without using mortar, so as to enable structures to be made that are more resistant and thermally better insulated.

In a first aspect of the invention, a composition is provided for producing a building item, comprising: finely subdivided inert materials, an alkali metal polysilicate, an oxidizing agent, formaldehyde.

In an embodiment, the oxidant comprises hydrogen peroxide.

In a second aspect of the invention, a method is provided for producing a building item, comprising:

dispersing finely subdivided inert materials in a solution of an alkali metal polysilicate, so as to obtain a mixture;

adding an oxidizing agent and formaldehyde to said mixture;

pouring said mixture into mould means so as to enable said mixture to expand in volume, solidify and produce said item;

dry said item.

In an embodiment, using hydrogen peroxide as oxidizing agent is provided.

Owing to these aspects, it is possible to make a building item, in particular a brick, provided with a lower specific weight (approximately 450 Kg/m³) compared with known bricks. This is made possible by the fact that the mixture, when it solidifies in the mould means, expands in volume owing to a chemical reaction that occurs between the formaldehyde, the oxidizing agent and the silicate.

The item that is thus obtained is such as to produce, in use, a lighter static load than that of known items and has mechanical properties that conform to regulations in force. In particular, the resistance to mechanical stresses is the same in each of the pairs of opposite faces of the item, which enables the latter to tolerate significant transverse tensions, such as occur, for example, in the event of seismic phenomena.

It is furthermore possible to completely use the loading volume of the industrial motor vehicles employed to transport building products, which enables several deliveries to be made, and more customers to be reached, by a single motor vehicle. This enables the commercial range of action of the brickyard that produce the aforementioned items to be significantly increased.

As the item provided by the invention is made by pouring a fluid mixture into mould means, it is possible to obtain items, for example bricks, having a preset and, above all, regular shape. Consequently, gaps do not form when these bricks are juxtaposed to one another and it is not therefore necessary to use mortar during laying of the bricks to close these gaps. It is therefore possible to use adhesive means of the known type, for example glue for building, to lay the bricks, which enables brick structures to be obtained that are more resistant and are thermally better insulated compared with structures made by using mortar and known bricks.

It is possible to add other components to the composition provided by the invention, such as for example fibres and/or polymers, so as to obtain an item provided with special mechanical resistance and/or impermeability properties. Furthermore, the method provided by the invention does not involve first drying the items and then baking the items in a kiln, which enables work time to be saved and avoids the use of complicated apparatuses.

The invention can be better understood and implemented with reference to the attached drawings, which illustrate an exemplifying but non-limitative embodiment thereof, in which:

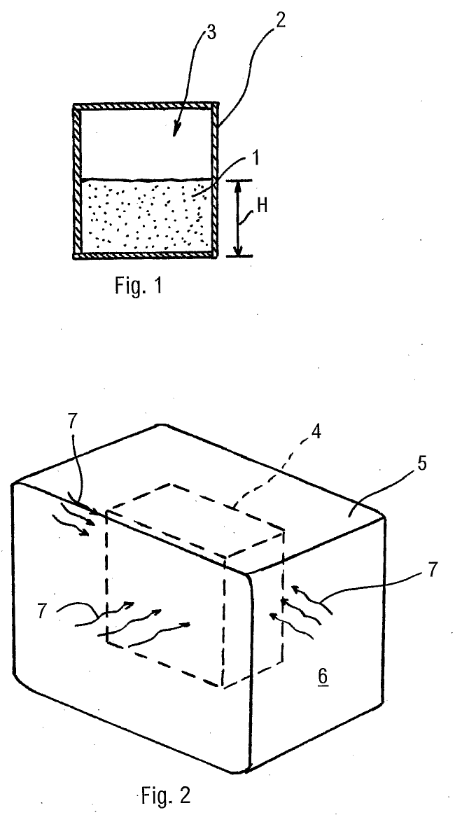

FIG. 1 is a schematic longitudinal section showing a step of a method for producing a building item;

FIG. 2 is a schematic perspective view showing a further step of a method for producing a building item.

With reference to FIGS. 1 and 2, a mixture 1 that is usable for producing a building item 4, for example a brick, is obtained from a composition having an average percentage formula expressed in the following table:

| Component | % range in weight |
|---|---|
| Ground inert materials | 10-70 |
| Alkali metal polysilicate | 20-90 |
| Oxidizing agent | 0.1-30 |
| Formaldehyde | 0.1-30 |

The ground inert materials can be obtained by grinding fragments of clay items (broken bricks), or from clay from clay pits, which is first baked at a temperature between 600-900° C. in a rotating kiln, which is of the known type and is not shown, and is subsequently ground. In both cases, grinding is performed in such a way as to produce inert materials having granulometry comprised between 50 mμ and 1 mm. The inert materials may also comprise sand, ceramic sludge or other things.

In an embodiment, the ground inert materials are equal to approximately 60% of the composition.

The alkali metal polysilicate may comprise sodium polysilicate (Na₂O.nSiO₂) and/or potassium polysilicate (K₂O.nSiO₂).

In an embodiment, the (sodium or potassium) polysilicate is equal to approximately 40% of the composition.

In an embodiment, the oxidizing agent comprises a water solution of hydrogen peroxide (H₂O₂) having a 35% (130 volume) concentration.

In an embodiment, the oxidizing agent is equal to approximately 5% of the composition.

The formaldehyde is used in the form of a water solution having a 24% concentration.

In an embodiment, the formaldehyde is equal to approximately 5% of the composition.

In use, a water solution of an alkali metal polysilicate, for example sodium polysilicate, is used, which acts as a binder for the mixture 1, and the ground inert materials are then dispersed in this solution.

Once the dispersion has been prepared, the hydrogen peroxide and the formaldehyde are introduced into the dispersion, triggering the following reaction:

2H₂O₂+CH₂O+[SiₙO₂ₙ+1]⁻⁻→3H₂O₂+CO₃⁻⁻+nSiO₂

During the above disclosed reaction, oxygen is produced, which causes the increase in the volume of the mixture, and carbonic acid is produced, which reacts with the polysilicate and forms a gel that is able to solidify in a substantially rapid manner.

In an embodiment, adding fibres to the dispersion, before the oxidizing agent and the formaldehyde, is provided, which fibres are capable of increasing the mechanical resistance of the product 4 deriving from the mixture 1. The fibres may be of vegetable origin, for example coconut or jute fibres, or be of organic origin (carbon, polypropylene) or be of inorganic origin (fibreglass).

In another embodiment, adding up to 15% of polymers, for example resins, to the dispersion before the oxidizing agent and the formaldehyde is provided, which polymers are able to increase the mechanical resistance or the impermeability of the item 4 deriving from the mixture 1.

In a further embodiment, adding both the fibres and polymers, before the oxidizing agent and the formaldehyde, is provided.

The mixture 1, once it has been prepared according to the procedure disclosed above, is poured into a cavity of a mould 2, which reproduces the shape and dimensions of the product 4 to be made, in such a quantity as to fill the cavity 3 until it reaches a preset height H in the cavity 3. In a time of approximately 15 minutes, owing to the above mentioned reaction that develops between the sodium polysilicate, the oxidizing agent and the formaldehyde, the mixture 1 expands in volume, completely occupying the cavity 3 of the mould 2, and simultaneously acquires a solid structure, thereby forming the item 4. After the above time has elapsed, the item 4 is extracted from the mould 2.

The item 4 contains a certain percentage of free water that has to be removed and is therefore placed in an internal chamber 6 of a microwave kiln 5 (FIG. 2), having specific power of approximately 1.2 KW/Kg_{H20}.

Inside the microwave kiln 5, the item 4 is subjected to the action of microwaves 7 having a frequency that is preferably equal to approximately 2450 MHz, for a time that is equal to approximately 20 minutes.

In an embodiment, using microwaves having a frequency equal to approximately 450 MHz is provided.

In another embodiment, using microwaves having a frequency equal to approximately 900 MHz is provided.

Once it is removed from the microwave kiln 5, the item 4 is completely dried and can be used directly or be suitably stored.

In an embodiment that is not shown, the item 4 is dried in a dryer of the thermodynamic type. The latter is provided with devices (of known type) that enable environmental humidity, speed of the air flow used during drying and wet bulb temperature to be determined and controlled. In fact, if the item 4 is dried in conventional dryers, the most external portion of the item 4 tends to dry prematurely and to thermally isolate the internal portion of the item 4. In the latter a temperature is thus not reached that is such as to enable the water contained therein to evaporate in an effective manner. As a result, the item 4 dries in an uneven and/or incomplete manner. By using the aforementioned dryer of thermodynamic type, on the other hand, it is possible to keep the temperature of the internal portion as close as possible to the temperature of the external portion, which substantially prevents the latter from drying prematurely. In this way, the item 4 can be dried in a homogeneous and complete manner.

The item 4 thus produced, in addition to having mechanical properties that conform to regulations in force, has a specific weight comprised between 100 and 1000 kg/m³, preferably equal to 450 kg/m³, which specific weight is therefore significantly lower than the specific weight of known items.

The shape and dimensions of each item 4 are regular and constant, inasmuch as they are defined by the shape and dimensions of the mould 2. As a result, it is not necessary to provide for the use of mortar to lay the item 4, but it is possible to use glue. In this way, brick structures can be built that are more resistant and better thermally insulated than the structures made with known bricks and mortar.

The rapidity of the method so far disclosed, the maximum length of which is approximately equal to 60 minutes as opposed to the 24-48 hours of the known methods, and the possibility of making the item 4 using a substantially simple plant are furthermore evident, as the kilns provided by known methods are not required.

1-58. (canceled)

59. Composition for producing a building item, comprising: finely subdivided inert materials, an alkali metal polysilicate, an oxidizing agent, formaldehyde.

60. Composition according to claim 59, having a percentage formula comprising:
finely subdivided inert materials 10-70%
alkali metal polysilicate 20-90%
oxidizing agent 0.1-30%
formaldehyde 0.1-30%

61. Composition according to claim 60, wherein said inert materials have a percentage value of 60.

62. Composition according to claim 60, wherein said polysilicate has a percentage value of 40.

63. Composition according to claim 60, wherein said oxidizing agent has a percentage value of 5.

64. Composition according claim 60, wherein said formaldehyde has a percentage value of 5.

65. Composition according to claim 59, wherein said inert materials are selected from a group comprising: ground fired clay, sand, ceramic sludge.

66. Composition according to claim 65, wherein said ground fired clay has granulometry comprised between 50 ml and 1 mm.

67. Composition according to claim 59, wherein said alkali metal polysilicate comprises a sodium polysilicate.

68. Composition according to claim 59, wherein said alkali metal polysilicate comprises a potassium polysilicate.

69. Composition according to claim 59, wherein said oxidizing agent comprises hydrogen peroxide.

70. Composition according to claim 69, wherein said hydrogen peroxide is in the form of a water solution having an approximately 35% concentration.

71. Composition according to claim 59, wherein said formaldehyde is in the form of a water solution.

72. Composition according to claim 71, wherein said water solution has an approximately 24% concentration.

73. Composition according to claim 59, furthermore comprising fibres of vegetable origin, said fibres of vegetable origin being selected from a group comprising: coconut fibres, jute fibres.

74. Composition according to claim 59, furthermore comprising organic fibres, said organic fibres being selected from a group comprising: carbon, polypropylene.

75. Composition according to claim 59, furthermore comprising inorganic fibres.

76. Composition according to claim 75, wherein said inorganic fibres comprise fibreglass.

77. Composition according to claim 59, furthermore comprising polymers capable of making said item significantly resistant to mechanical stresses and/or humidity.

78. Composition according to claim 77, wherein said polymers have a percentage by weight that is equal to approximately 15%.

79. Composition according to claim 77, wherein said polymers comprise resins.

80. Method for producing a building item, comprising:
dispersing finely subdivided inert materials in a solution of an alkali metal polysilicate, so as to obtain a mixture;
adding an oxidizing agent and formaldehyde to said mixture;
pouring said mixture into a mould, so as to enable said mixture to solidify and produce said item;
dry said item.

81. Method according to claim 80, comprising selecting said inert materials from a group comprising: ground fired clay, sand, ceramic sludge.

82. Method according to claim 81, wherein said ground fired clay has granulometry comprised between 50 mμ and 1 mm.

83. Method according to claim 80, wherein said dispersing inert materials occurs in a solution of sodium polysilicate.

84. Method according to claim 80, wherein said dispersing inert materials occurs in a solution of potassium polysilicate.

85. Method according to claim 80, wherein said pouring comprises partially filling said mould, i.e. to a preset level.

86. Method according to claim 80, wherein said drying is performed after removing said item from said mould.

87. Method according to claim 80, wherein said drying comprises using a microwave kiln.

88. Method according to claim 87, wherein said microwave kiln has specific power equal to approximately 1.2 KW/Kg H20.

89. Method according to claim 87, wherein said drying comprises using microwaves having a frequency selected from a group comprising: 2450 MHz, 900 MHz, 450 MHz.

90. Method according to claim 80, wherein said drying lasts for a period of approximately 20 minutes.

91. Method according to claim 80, wherein said drying comprises determining and controlling environmental humidity, wet bulb temperature and speed of a drying air flow.

92. Method according to claim 91, wherein said drying comprises using a thermodynamic dryer, said thermodynamic dryer being provided with devices for determining and/or controlling said environmental humidity, said wet bulb temperature and said speed of said drying air flow.

93. Method according to claim 80, wherein said finely subdivided inert materials have a percentage by weight that is comprised between 10% and 70%.

94. Method according to claim 93, wherein said finely subdivided inert materials have a percentage by weight that is equal to approximately 60%.

95. Method according to claim 80, wherein said alkali metal polysilicate has a percentage by weight that is comprised between 20% and 90%.

96. Method according to claim 95, wherein said alkali metal polysilicate has a percentage by weight that is equal to approximately 40%.

97. Method according to claim 80, wherein said oxidizing agent has a percentage by weight that is comprised between 0.1% and 30%.

98. Method according to claim 97, wherein said oxidizing agent has a percentage by weight that is equal to approximately 5%.

99. Method according to claim 80, wherein said oxidizing agent comprises a hydrogen peroxide solution.

100. Method according to claim 99, wherein said oxidizing agent is used in the form of an approximately 35% water solution.

101. Method according to claim 80, wherein said formaldehyde has a percentage by weight that is comprised between 0.1% and 30%.

102. Method according to claim 101, wherein said formaldehyde has a percentage by weight that is equal to approximately 5%.

103. Method according to claim 80, wherein said formaldehyde is used in the form of a water solution.

104. Method according to claim 103, wherein said water solution has a concentration that is equal to approximately 24%.

105. Method according to claim 80, furthermore comprising adding fibres of vegetable origin to said mixture, said fibres of vegetable origin being selected from a group comprising: cocoanut fibres, jute fibres.

106. Method according to claim 105, wherein said adding said fibres of vegetable origin occurs before said adding said oxidizing agent and said formaldehyde.

107. Method according to claim 80, furthermore comprising adding organic fibres to said mixture, said organic fibres being selected from a group comprising: carbon, polypropylene.

108. Method according to claim 107, wherein said adding said organic fibres occurs before said adding said oxidizing agent and said formaldehyde.

109. Method according to claim 80, furthermore comprising adding inorganic fibres to said mixture, said inorganic fibres comprising fibreglass.

110. Method according to claim 109, wherein said adding said inorganic fibres occurs before said adding said oxidizing agent and said formaldehyde.

111. Method according to claim 80, furthermore comprising adding polymers to said mixture, said polymers comprising resins and being such as to make said item significantly resistant to mechanical stresses and/or humidity.

112. Method according to claim 111, wherein said adding polymers occurs before said adding said oxidizing agent and said formaldehyde.

113. Method according to claim 111, wherein said polymers have a percentage by weight that is equal to approximately 15%.

114. Method according to claim 80, wherein said item, after said drying, has a specific weight that is comprised between 100 and 1000 kg/m3.

115. Method according to claim 114, wherein said specific weight is equal to approximately 450 kg/m3.

116. Method according to claim 80, wherein said item is selected from a group comprising: bricks, panels.
